(19) United States
(12) Patent Application Publication
(10) Pub. No.: US 2022/0316908 A1
(43) Pub. Date: Oct. 6, 2022

(54) VEHICLE CONTROL DEVICE, CONTROL METHOD, AND STORAGE MEDIUM

(71) Applicant: HONDA MOTOR CO., LTD., Tokyo (JP)

(72) Inventor: Noriyuki Abe, Tokyo (JP)

(21) Appl. No.: 17/680,350

(22) Filed: Feb. 25, 2022

(30) Foreign Application Priority Data
Mar. 31, 2021 (JP) 2021-062127

(51) Int. Cl. G01C 21/36; B60L 8/00; B60W 60/00

(52) U.S. Cl. CPC G01C 21/3691; B60L 8/003; B60W 60/001; B60W 2555/20; B60W 2720/10; B60W 2520/105; B60W 2555/60

(57) ABSTRACT

A vehicle control device which is used in a vehicle traveling by electric power generated by solar power generation, includes: a solar radiation information acquisition unit which acquires solar radiation information showing a solar radiation amount on a travel route which is a planned travel route; and a target speed determination unit which determines a target speed on the travel route on the basis of the solar radiation information acquired by the solar radiation information acquisition unit and information in which the solar radiation amount is associated with the speed.

### CROSS-REFERENCE TO RELATED APPLICATION

Priority is claimed on Japanese Patent Application No. 2021-062127, filed Mar. 31, 2021, the content of which is incorporated herein by reference.

### BACKGROUND OF THE INVENTION

### Field of the Invention

The present invention relates to a vehicle control device, a control method, and a storage medium.

### Description of Related Art

Conventionally, a vehicle that travels using electric power generated by sunlight is known. As related technologies, it is disclosed to select a traveling route with good solar radiation conditions and not to turn off a device that generates solar power when passing through a shade temporarily (for example, Japanese Unexamined Patent Application No. 2017-125803 and Japanese Unexamined Patent Application No. 2016-163473).

### SUMMARY OF THE INVENTION

However, the related technologies are only for determining the vehicle speed or acceleration by selecting the route of the shortest distance or minimum energy and cannot efficiently generate electric power.

An aspect of the present invention is made in view of such circumstances and an object thereof is to provide a vehicle control device, a control method, and a storage medium capable of efficiently generating electric power.

In order to attain the object for solving the above-described problems, the present invention adopts the following aspects.

(1) A vehicle control device according to an aspect of the present invention is a vehicle control device which is used in a vehicle traveling by electric power generated by solar power generation, including: a solar radiation information acquisition unit which acquires solar radiation information showing a solar radiation amount on a travel route which is a planned travel route; and a target speed determination unit which determines a target speed on the travel route on the basis of the solar radiation information acquired by the solar radiation information acquisition unit and information in which the solar radiation amount is associated with the speed.

(2) In the aspect (1), the vehicle may be an autonomous driving vehicle which travels without any operation of a driver, and the vehicle control device may further include a vehicle speed control unit which controls a vehicle speed on the basis of the target speed determined by the target speed determination unit.

(3) In the aspect (1), the vehicle may be a vehicle which is driven by a driver, and the vehicle control device may further include a vehicle speed change recommendation unit which recommends a vehicle speed change to the driver on the basis of the target speed determined by the target speed determination unit.

(4) In any one of the aspects (1) to (3), the solar radiation information acquisition unit may acquire the solar radiation information at a predetermined timing until the vehicle arrives at a destination, and the target speed determination unit may correct the target speed on the basis of the solar radiation information acquired at the predetermined timing.

(5) In the aspect (4), the vehicle control device may further include a comparison result acquisition unit which acquires a comparison result obtained by comparing the solar radiation information acquired at the predetermined timing with the solar radiation information used for determining the target speed, and the target speed determination unit may correct the target speed when the comparison result exceeds a predetermined threshold value.

(6) In any one of the aspects (1) to (5), the target speed determination unit may determine target acceleration and deceleration when changing the vehicle speed to the target speed on the basis of information on acceleration and deceleration when changing the vehicle speed.

(7) In the aspect (6), the vehicle control device may further include a traveling state acquisition unit which acquires information on a traveling state of a peripheral vehicle traveling in the periphery of an own vehicle, and the target speed determination unit may determine the acceleration and deceleration on the basis of information on the acceleration and deceleration and information on the traveling state.

(8) In any one of the aspects (1) to (7), the target speed determination unit may determine the target speed on the basis of road restriction information on restrictions on the travel route.

(9) In any one of the aspects (1) to (8), the target speed determination unit may determine the target speed on the basis of accident occurrence rate information showing an accident occurrence rate on the travel route.

(10) A control method according to another aspect of the present invention allows a computer used in a vehicle traveling by electric power generated by solar power generation to acquire solar radiation information showing a solar radiation amount on a travel route which is a planned travel route and determine a target speed on the travel route on the basis of the acquired solar radiation information and information in which the solar radiation amount is associated with the speed.

(11) A computer-readable non-temporary storage medium according to another aspect of the present invention stores a program allowing a computer used in a vehicle traveling by electric power generated by solar power generation to acquire solar radiation information showing a solar radiation amount on a travel route which is a planned travel route and determine a target speed on the travel route on the basis of the acquired solar radiation information and information in which the solar radiation amount is associated with the speed.

According to (1) to (11), it is possible to efficiently generate electric power.

### BRIEF DESCRIPTION OF THE DRAWINGS

FIG. 1 is a diagram showing an example of a configuration of a vehicle M according to a first embodiment.

FIG. 2 is a diagram showing an example of an outline of the first embodiment.

FIG. 3 is a diagram showing an example of a vehicle control device 100 according to the first embodiment.

FIG. 4 is a flowchart showing an example of a vehicle control process which is performed by the vehicle control device 100 according to the first embodiment.

FIG. 5 is a diagram showing an example of a vehicle control device 100 according to a second embodiment.

FIG. 6 is a flowchart showing an example of a vehicle control process which is performed by a vehicle control device 500 according to the second embodiment.

FIG. 7 is a screen example showing a recommendation for changing a vehicle speed according to the second embodiment.

FIG. 8 is a screen example showing a recommendation for changing a vehicle speed according to the second embodiment.

### DETAILED DESCRIPTION OF THE INVENTION

### Embodiments

Hereinafter, first and second embodiments of a vehicle, a control device, a control method, and a storage medium of the present invention will be described with reference to the drawings.

### First Embodiment

### Example of Vehicle M

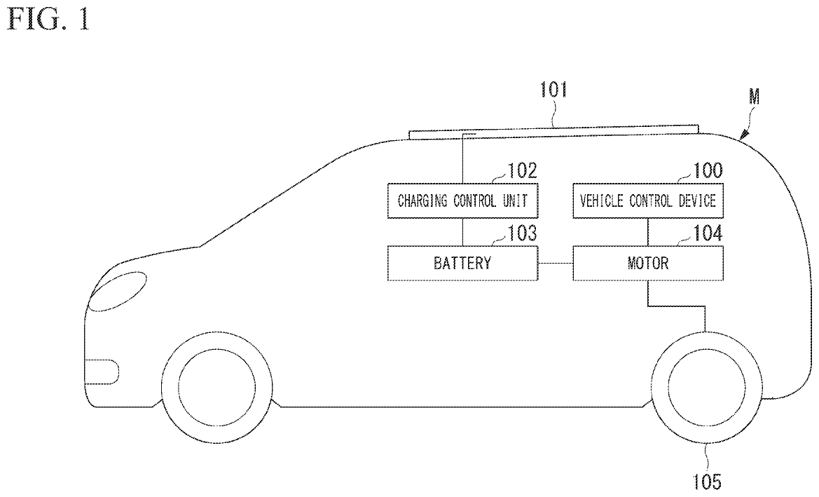

FIG. 1 is a diagram showing an example of a configuration of a vehicle M according to a first embodiment. The vehicle M shown in FIG. 1 is an electric vehicle (EV vehicle) that travels using electric power generated by sunlight. The vehicle M is the EV vehicle, but the present invention is not limited thereto if the vehicle includes a solar panel 101. For example, the vehicle M can be a hybrid vehicle (HV) or a plug-in hybrid vehicle (PHV).

The vehicle M is a vehicle capable of performing autonomous driving that automatically travels without the operation of the driver. The autonomous driving is, for example, fully autonomous driving in which a system always performs all driving tasks. The autonomous driving may be, for example, a state in which at least one of the driving support functions such as an adaptive cruise control (ACC), a lane keep assist system (LKAS), a collision mitigation brake system (CMBS), and a traffic jam assist function is turned on.

As shown in FIG. 1, the vehicle M includes a vehicle control device 100, a solar panel 101, a charging control unit 102, a battery 103, a motor 104, and a drive wheel 105. The vehicle control device 100 controls the entire vehicle. The vehicle control device 100 controls the driving by using the detection result of various sensors provided in the vehicle M or various input information. The vehicle control device 100 is realized by, for example, an electronic control unit (ECU).

The solar panel 101 absorbs the light energy of the sun to generate electric power. The charging control unit 102 charges the battery 103 with the electric power generated by the solar panel 101. The motor 104 drives and rotates the drive wheel 105 using the electric power charged in the battery 103 based on the control of the vehicle control device 100. The vehicle M includes an in-vehicle camera that captures an image on the front side and an in-vehicle camera that captures an image on the rear side. [Example of outline of embodiments]

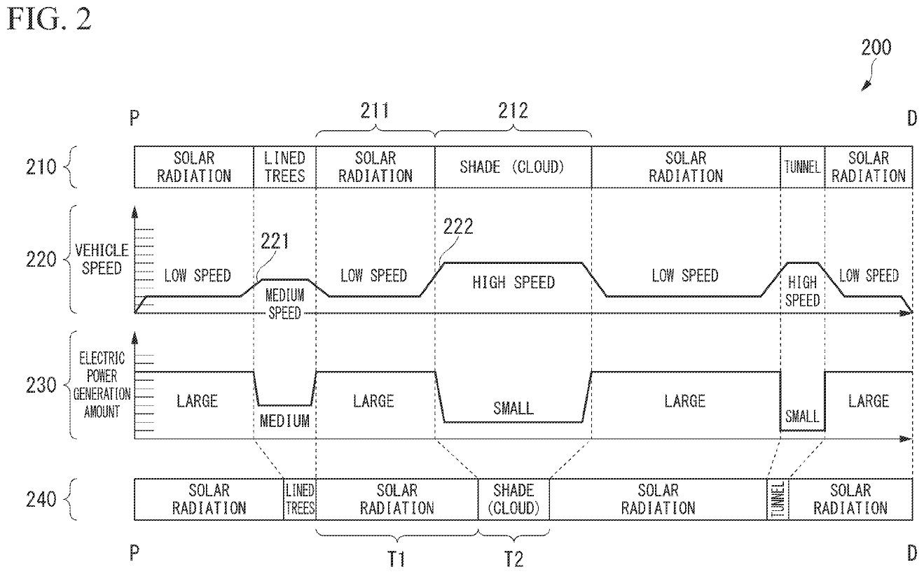

FIG. 2 is a diagram showing an example of an outline of the first embodiment. In this embodiment, the speed of the vehicle M is adjusted for the purpose of obtaining the maximum solar energy of the vehicle M in fine weather. As shown in FIG. 2, the vehicle M travels from a departure place P to a destination D in fine weather at the speed indicated by a vehicle speed distribution map 220 in consideration of the amount of power generated by sunlight.

An outline diagram 200 shown in FIG. 2 includes a solar radiation distribution map 210, a vehicle speed distribution map 220, electric power generation amount information 230, and required time information 240. The solar radiation distribution map 210 shows the distribution of the solar radiation amount on the travel route which is a planned travel route. Specifically, the solar radiation distribution map 210 is a map showing the solar radiation amount at each place (each region) on the route from a first position to a second position. The first position is, for example, a departure place, a current position, a position to be passed in the future, and the like. The second position is, for example, a destination, a position to be passed after passing the first point, and the like.

The solar radiation distribution map 210 shows the solar radiation amount on the route. In this embodiment, for convenience of description, the solar radiation amount is represented by three levels of “large”, “medium”, and “small” In the solar radiation distribution map 210, the “solar radiation” (solar radiation region 211 shown in the figure) indicates a place on the road where there is nothing blocking the sunlight. That is, it shows a place in which the solar radiation amount is “large”. The “lined trees” indicating a shaded tree-lined road and the “shade (cloud)” (shaded region 212 in the figure) indicating a cloudy sky indicate places where the solar radiation amount is “medium”. The “tunnel” with little sunlight will indicate that the solar radiation amount is “small”.

The vehicle speed distribution map 220 is a map relating to the vehicle speed on the travel route. Specifically, the vehicle speed distribution map 220 is a map showing a target speed (and a target acceleration) for each position on the route. Here, in order to generate electric power efficiently, the solar radiation amount and the vehicle speed have a contradictory relationship in terms of increase and decrease. Specifically, in order to generate electric power efficiently, the low-speed traveling is effective when the solar radiation amount is large, the medium-speed traveling is effective when the solar radiation amount is medium, and the high-speed traveling is effective when the solar radiation amount is small. In the vehicle speed distribution map 220, the speed corresponding to the solar radiation region 211 indicates a low speed and the speed corresponding to the shaded region 212 indicates a high speed.

The speed shall be such that there is no problem in terms of safety and law. Specifically, the speed is a speed that does not exceed the legal speed or the specified speed even when the maximum speed is set. The low speed is a speed considering the speed of the peripheral vehicle, for example, a speed that is about 10 to 20% slower than the speed of the peripheral vehicle. If there is no peripheral vehicle, the speed can be set to any speed according to the user's selection. Since the vehicle M is an autonomous driving vehicle, the user can complete some errands in the vehicle. Therefore, it is not necessary to give top priority to arriving at the destination D in the shortest time. From this, when there is no peripheral vehicle, it is possible to set the speed to a slower speed without considering the arrival time.

The vehicle speed distribution map 220 is also a map showing the acceleration when shifting to the target speed. For example, the vehicle speed distribution map 220 shows that the acceleration 221 (slope) when shifting from a low speed to a medium speed is smaller than the acceleration 222 (slope) when shifting from a low speed to a high speed. That is, the figure shows that an acceleration operation is smoothly performed when shifting from a low speed to a medium speed and an acceleration operation is performed at a larger acceleration when shifting from a low speed to a high speed.

The electric power generation amount information 230 shows the target electric power generation amount for each position on the route. Here, the electric power generation amount of the solar power generation has a relation of an increase as the solar radiation amount increases. Specifically, the electric power generation amount is large when the solar radiation amount is large, is medium when the solar radiation amount is medium, and is small when the solar radiation amount is small. The electric power generation amount becomes large since the vehicle travels at a low speed in a place in which the solar radiation amount is large. On the other hand, the electric power generation amount becomes small since the vehicle travels at a high speed in a place in which the solar radiation amount is small Specifically, the electric power generation amount information 230 shows that the electric power generation amount corresponding to the solar radiation region 211 is large and the electric power generation amount corresponding to the shaded region 212 is small.

The required time information 240 shows the required time for passing each place on the route from the departure place P to the destination D. For example, the required time is necessary since the vehicle moves at a low speed in a place in which the solar radiation amount is large. Specifically, the figure shows that it takes time T1 to pass through the solar radiation region 211. On the other hand, since the vehicle moves at a high speed in a place in which the solar radiation amount is small, the required time becomes short. Specifically, the figure shows that it takes time T2 to pass the shaded region 212. The shaded region 212 is a section which is longer than the solar radiation region 211, but since the vehicle moves at a high speed in the shaded region 212, the time T2 for passing the shaded region 212 becomes shorter than the time T1 for passing the solar radiation region 211.

In this way, in this embodiment, since the vehicle M is moved at a low speed in a place in which the solar radiation amount is large and the vehicle is moved at a high speed in a place in which the solar radiation amount is small, power is efficiently generated. Specifically, the power generation time is lengthened as much as possible by reducing the speed of the vehicle M to the extent that there is no practical problem in a place in which the solar radiation is satisfactory. On the other hand, the staying time is shortened as much as possible by increasing the speed of the vehicle M to the extent that there is no problem in safety and law in places in which solar radiation conditions are poor, such as cloud, lined trees, and tunnels. In this way, it is designed to reduce loss.

### Example of Vehicle Control Device 100 According to First Embodiment

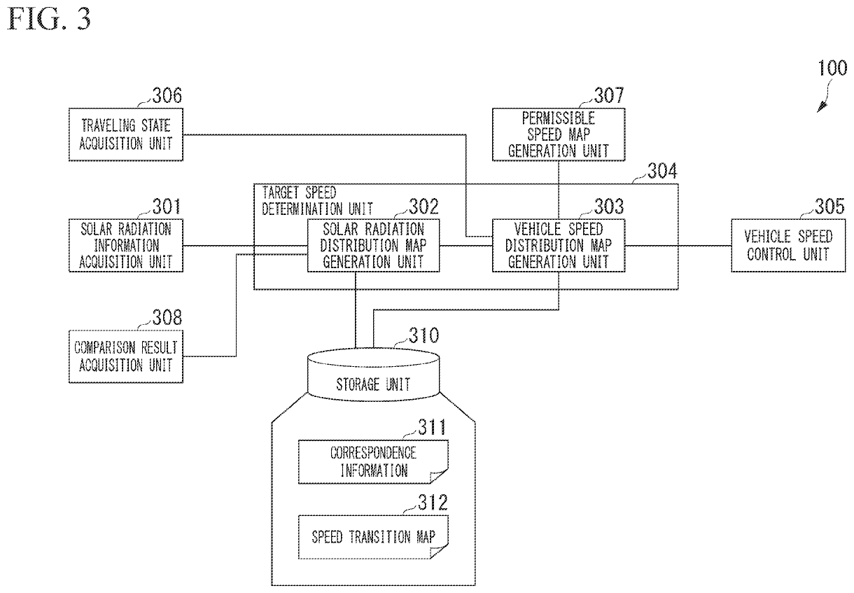

FIG. 3 is a diagram showing an example of the vehicle control device 100 according to the first embodiment. As shown in FIG. 3, the vehicle control device 100 includes a solar radiation information acquisition unit 301, a solar radiation distribution map generation unit 302, a vehicle speed distribution map generation unit 303, a target speed determination unit 304, a vehicle speed control unit 305, a traveling state acquisition unit 306, a permissible speed map generation unit 307, and a comparison result acquisition unit 308.

Each of these components is realized by executing a program (software) by a hardware processor such as a central processing unit (CPU). A part or all of these components may be realized by hardware (including circuitry) such as a large scale integration (LSI), an application specific integrated circuit (ASIC), a field-programmable gate array (FPGA), and a graphics processing unit (GPU) or may be realized by a combination of software and hardware. The program may be stored in advance in a storage device (not shown) such as a HDD or a flash memory of the vehicle control device 100 or may be stored in a removable storage medium such as a DVD or a CD-ROM to be installed in the HDD or the flash memory of the vehicle control device 100 when the storage medium is attached to a drive device.

The vehicle control device 100 includes a storage unit 310. The storage unit 310 is realized by, for example, a storage device such as a random access memory (RAM), a read only memory (ROM), a hard disk drive (HDD), and a flash memory. The information stored in the storage unit may be stored in an external device to which the vehicle control device 100 is accessible.

The solar radiation information acquisition unit 301 acquires the solar radiation information showing the solar radiation amount on the travel route. The travel route is, for example, a route from the departure place P to the destination D. The solar radiation information includes communication information such as the Internet, video information such as an in-vehicle camera, and the electric power generation amount of the solar panel 101. Specifically, the solar radiation information acquisition unit 301 acquires the solar radiation information from communication information (weather information) such as the Internet, television, and radio. The solar radiation information acquisition unit 301 acquires the solar radiation information from the image result obtained by capturing the front side of the vehicle M by the in-vehicle camera. The solar radiation information acquisition unit 301 acquires the solar radiation information from the electric power generation amount of the solar panel 101.

The solar radiation information is also included in the map data. The map data includes, for example, information that the road is a tree-lined road. The position of shade on the tree-lined road may differ depending on the time of day and the season. Therefore, the map data referred to for acquiring the solar radiation amount is the map data for each time zone or season.

The solar radiation information is information showing the solar radiation amount of “high”, “medium”, or “low” for each place on the route. The solar radiation information acquisition unit 301 may acquire information on the route indicating “solar radiation, “lined trees”, “shade”, and “tunnel”. However, the information on these routes may be associated with the information showing the solar radiation amount, and the solar radiation information acquisition unit 301 may derive the information showing the solar radiation amount from the acquired information on the route.

The storage unit 310 stores correspondence information 311. The correspondence information 311 is information in which the solar radiation amount and the speed for efficient power generation are associated with each other. The correspondence information 311 is information showing that the increase and decrease has a contradictory relationship between the solar radiation amount and the vehicle speed. Specifically, the correspondence information 311 is information in which the solar radiation amount and the target speed are associated with each other as follows.
Solar radiation amount “small”—target speed “high speed”.
Solar radiation amount “medium”—target speed “medium speed”.
Solar radiation amount “large”—target speed “low speed”.
The correspondence information 311 is associated with the electric power generation amount as follows.
Solar radiation amount “small”—target speed “high speed”—electric power generation amount “small”.
Solar radiation amount “medium”—target speed “medium speed”—electric power generation amount “medium”.
Solar radiation amount “large”—target speed “low speed”—electric power generation amount “large”.

The target speed determination unit 304 determines the target speed on the travel route on the basis of the solar radiation information acquired by the solar radiation information acquisition unit 301 by referring to the correspondence information 311. Specifically, for example, when the solar radiation information acquired by the solar radiation information acquisition unit 301 shows that the solar radiation amount is “large”, the target speed determination unit 304 determines the target speed of the “low speed” by referring to the correspondence information 311. Accordingly, it is possible to obtain a large electric power generation amount when the solar radiation amount is “large”.

The solar radiation information may include at least one of communication information such as the Internet, video information such as an in-vehicle camera, and the electric power generation amount of the solar panel 101. Therefore, the target speed determination unit 304 may determine the target speed on the travel route only based on communication information such as the Internet. For example, the target speed determination unit 304 may determine the target speed on the travel route only based on video information such as an in-vehicle camera.

The determination of the target speed will be described in detail. The target speed determination unit 304 includes the solar radiation distribution map generation unit 302 and the vehicle speed distribution map generation unit 303. The solar radiation distribution map generation unit 302 generates the solar radiation distribution map 210 on the basis of the solar radiation information acquired by the solar radiation information acquisition unit 301. The solar radiation distribution map 210 is a map of information showing the solar radiation amount for each place on the travel route. Hereinafter, the solar radiation distribution map 210 generated when the destination D is set may be referred to as an “initial solar radiation distribution map 210”.

The vehicle speed distribution map generation unit 303 generates the vehicle speed distribution map 220 showing the target speed at each place on the travel route on the basis of the solar radiation distribution map 210 generated by the solar radiation distribution map generation unit 302 by referring to the correspondence information 311 stored in the storage unit 310. Specifically, for example, the vehicle speed distribution map generation unit 303 generates the vehicle speed distribution map 220 in which the target speed is set to a high speed in a place in which the solar radiation amount is “small” and the target speed is set to a low speed in a place in which the solar radiation amount is “large”.

The vehicle speed control unit 305 controls the vehicle speed on the basis of the target speed determined by the target speed determination unit 304. Specifically, the vehicle speed control unit 305 controls the vehicle speed on the basis of the information showing the vehicle speed distribution map 220 generated by the vehicle speed distribution map generation unit 303. The vehicle speed control unit 305 controls the motor 104 so that the vehicle M travels at a speed and an acceleration indicated by the vehicle speed distribution map 220 for each place on the travel route.

### [Correction of Solar Radiation Distribution Map 210]

The solar radiation information acquisition unit 301 acquires the solar radiation information at a predetermined timing at any time until the vehicle arrives at the destination D. Here, the in-vehicle camera captures the front changing scenery while the vehicle M is traveling. The solar radiation information acquisition unit 301 acquires the solar radiation information from the image result captured by the in-vehicle camera. The predetermined timing is the timing at which the image result regarding the solar radiation information is obtained, for example, the timing at which the front cloud image is captured. For example, when the front cloud image is captured, the solar radiation information acquisition unit 301 identifies a position in which the cloud exists and acquires “shade” (=“small”) as information on the solar radiation amount.

The solar radiation information acquisition unit 301 acquires not only the solar radiation information from the image result of the in-vehicle camera, but also the electric power generation amount of the solar panel 101 or the solar radiation information from the internet at any time (a predetermined timing) until the vehicle arrives at the destination D. Hereinafter, the recent solar radiation information among the solar radiation information acquired at any time until the vehicle arrives at the destination D may be referred to as “observation information”.

The solar radiation distribution map generation unit 302 corrects the solar radiation distribution map 210 on the basis of the observation information. Therefore, the solar radiation distribution map 210 is temporarily corrected (updated) until the vehicle arrives at the destination D. In this way, in this embodiment, the vehicle speed distribution map 220 is generated on the basis of the solar radiation distribution map 210 and the vehicle speed distribution map 220 is corrected on the spot on the basis of the image result (observation information) captured by the in-vehicle camera.

The comparison result acquisition unit 308 acquires a comparison result obtained by comparing the solar radiation information acquired at a predetermined timing with the solar radiation information used for determining the target speed. The comparison result is, for example, a difference (or a ratio) between the solar radiation amount at the predetermined timing and the solar radiation amount used when determining the target speed. The solar radiation distribution map generation unit 302 corrects the solar radiation distribution map 210 when the comparison result exceeds a predetermined threshold value. The threshold value is a value which is changed by the performance of the solar panel 101 or consuming power. When the solar radiation distribution map 210 is corrected, the vehicle speed distribution map generation unit 303 corrects the vehicle speed distribution map 220 on the basis of the corrected solar radiation distribution map 210.

Although the comparison result acquisition unit 308 is configured to acquire the comparison result, the vehicle control device 100 may include a function unit for performing the comparison. Specifically, the vehicle control device 100 may include a comparison unit which compares the solar radiation information acquired at the predetermined timing with the solar radiation information used for determining the target speed.

### [Acceleration and Deceleration of Vehicle M]

The storage unit 310 stores a speed transition map 312 in advance. The speed transition map 312 is information on acceleration and deceleration when changing the vehicle speed. Specifically, the speed transition map 312 is a map showing a driving force calculated to have a smooth and appropriate speed transition curve in consideration of the riding comfort and traveling loss when the speed is changed (accelerated/decelerated) from a certain vehicle speed to a target vehicle speed.

The target speed determination unit 304 determines the target acceleration and deceleration when changing the vehicle speed to the target speed by referring to the speed transition map 312. The determination of acceleration and deceleration will be described in detail. The vehicle speed distribution map generation unit 303 generates the vehicle speed distribution map 220 on the basis of the speed transition map 312 and the solar radiation distribution map 210 stored in the storage unit 310.

Here, as described above, the vehicle travels at a high speed in the tunnel. If it is assumed that the vehicle is suddenly accelerated in the vicinity of the entrance of the tunnel when there is another vehicle in front of the vehicle, the distance of the vehicle with respect the front vehicle becomes short. When the vehicle exits the tunnel, the vehicle travels at a low speed. If the vehicle is suddenly decelerated when there is another vehicle behind the vehicle, there is a risk that the rear vehicle may collide with the vehicle. Therefore, the vehicle control device 100 performs acceleration and deceleration in consideration of the peripheral vehicle.

Specifically, the traveling state acquisition unit 306 acquires information on the traveling state of the peripheral vehicle traveling in the periphery of the vehicle M. The peripheral vehicle is, for example, a vehicle that travels in front of or behind the own vehicle. The information on the traveling state of the peripheral vehicle includes information on the speed of the peripheral vehicle or information on the distance between the vehicle M and the peripheral vehicle. The traveling state acquisition unit 306 acquires information on the traveling state of the peripheral vehicle from the image result of the in-vehicle camera capturing an image on the front side and the in-vehicle camera capturing an image on the rear side.

The target speed determination unit 304 determines acceleration and deceleration by referring to the information on the traveling state of another vehicle and the speed transition map 312. The determination of acceleration and deceleration will be described in detail. The vehicle speed distribution map generation unit 303 determines the acceleration and deceleration of the vehicle speed distribution map 220 on the basis of the information on the traveling state of another vehicle. Specifically, the vehicle speed distribution map generation unit 303 determines the acceleration and deceleration in consideration of aggression (sudden acceleration, sudden deceleration) to the peripheral vehicle. More specifically, the vehicle speed distribution map generation unit 303 determines the acceleration and deceleration so that the vehicle is not suddenly accelerated or decelerated when there is the peripheral vehicle.

### [Driving Regulations on Travel Route]

Next, driving regulations and the like on the travel route will be described. The permissible speed map generation unit 307 stores a permissible speed map. The permissible speed map includes road restriction information. The road restriction information is restrictions on the use of roads due to regulations, time, weather conditions, and the like. Specifically, for example, the road restriction information is information such as a maximum speed, a minimum speed, a travel classification designation, a time designation, a school zone, road construction information, and traffic restriction information (snow cover, storm).

The permissible speed map generation unit 307 acquires this information from the map data or acquires the information using the Internet, radio, or the like. For example, information such as a maximum speed, a minimum speed, a travel classification designation, a time designation, and a school zone are acquired from map data. Road construction information and traffic restriction information (snow cover, storm) are obtained from the Internet and the like.

The target speed determination unit 304 determines the target speed by referring to the permissible speed map generation unit 307. The determination of the target speed will be described in detail. The vehicle speed distribution map generation unit 303 generates the vehicle speed distribution map 220 by referring to the road restriction information included in the permissible speed map. For example, the vehicle speed distribution map generation unit 303 generates the vehicle speed distribution map 220 in which the vehicle does not travel at a sudden acceleration or a high speed in a school zone.

The permissible speed map includes accident occurrence rate information. The accident occurrence rate information is information showing an accident occurrence rate on the traveling route. The permissible speed map generation unit 307 acquires the accident occurrence rate information from the map data or by the Internet or radio. The vehicle speed distribution map generation unit 303 generates the vehicle speed distribution map 220 by referring to the accident occurrence rate information included in the permissible speed map. For example, the vehicle speed distribution map generation unit 303 generates the vehicle speed distribution map 220 in which the vehicle does not travel at a sudden acceleration or a high speed in a place in which an accident occurrence rate is high.

### [Vehicle Control Process Performed by Vehicle Control Device 100 According to First Embodiment]

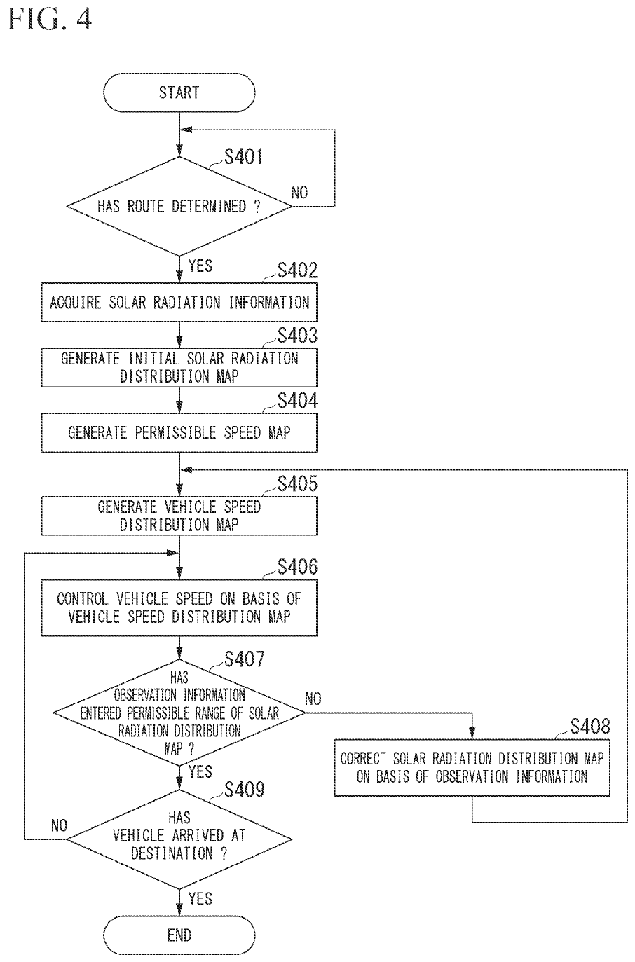

FIG. 4 is a flowchart showing an example of a vehicle control process which is performed by the vehicle control device 100 according to the first embodiment. In FIG. 4, the vehicle control device 100 determines whether or not the destination D is set, the route is searched, and the route to the destination D is determined (step S401). The solar radiation information acquisition unit 301 waits until the route is determined and acquires the solar radiation information when the route is determined (step S402). Then, the solar radiation distribution map generation unit 302 generates an initial solar radiation distribution map 210 on the basis of the solar radiation information (step S403).

Then, the permissible speed map generation unit 307 generates a permissible speed map by acquiring the road restriction information or the accident occurrence rate information (step S404). Next, the vehicle speed distribution map generation unit 303 generates the vehicle speed distribution map 220 by using the solar radiation distribution map 210 generated by the solar radiation distribution map generation unit 302 and the permissible speed map generated by the permissible speed map generation unit 307 (step S405). Then, the vehicle speed control unit 305 controls the vehicle speed on the basis of the vehicle speed distribution map 220 (step S406).

Next, the solar radiation distribution map generation unit 302 determines whether or not the observation information is within a permissible range of the solar radiation distribution map 210 (step S407). Specifically, the solar radiation distribution map generation unit 302 determines whether or not a difference between the solar radiation amount indicated by the observation information and the solar radiation amount when generating or correcting the solar radiation distribution map 210 exceeds a threshold value. When the observation information is not within the permissible range of the solar radiation distribution map 210, that is, the difference between the solar radiation amount indicated by the observation information and the solar radiation amount when generating or correcting the solar radiation distribution map 210 exceeds the threshold value, the solar radiation distribution map generation unit 302 corrects the solar radiation distribution map 210 on the basis of the observation information (step S408) and shifts to step S405.

When the observation information is within the permissible range of the solar radiation distribution map 210, the vehicle control device 100 determines whether or not the vehicle arrives at the destination D (step S409). When the vehicle does not arrive at the destination D, the vehicle control device 100 returns to step S406. When the vehicle arrives at the destination D, the vehicle control device 100 ends a series of processes.

As described above, in this embodiment, the target speed is determined on the basis of the solar radiation information acquired with reference to the correspondence information 311 showing the relationship between the solar radiation amount and the target speed. Specifically, the vehicle speed distribution map 220 that maximizes the electric power generation amount over the entire travel route is generated by obtaining information on the solar radiation shield such as a cloud or a tunnel when the travel route to the destination D is determined. Accordingly, the speed at each place on the travel route can be set to the speed corresponding to the solar radiation amount. Specifically, the vehicle can travel at a low speed in a place in which the solar radiation amount is large and the vehicle can travel at a high speed in a place in which the solar radiation amount is small. Thus, it is possible to efficiently generate electric power.

In this embodiment, the vehicle M is set as an autonomous driving vehicle and the vehicle speed is controlled on the basis of the determined target speed. Thus, it is possible to efficiently generate electric power in the autonomous driving vehicle.

In this embodiment, the vehicle control device 100 is configured to correct the target speed on the basis of the observation information acquired at any time until the vehicle arrives at the destination D. Thus, it is possible to generate power in accordance with the solar radiation amount on the travel route.

In this embodiment, the vehicle control device 100 is configured to correct the target speed when the comparison result obtained by comparing the observation information with the solar radiation information used for determining the target speed exceeds a predetermined threshold value. Accordingly, it is possible to correct the solar radiation distribution map 210 and the vehicle speed distribution map 220 when the predicted solar radiation amount and the actual solar radiation amount are different to a certain extent. Thus, it is possible to perform the correct at an optimal timing by suppressing the frequent correction of the solar radiation distribution map 210 and the vehicle speed distribution map 220.

In this embodiment, the vehicle control device 100 is configured to determine the target acceleration and deceleration when the vehicle speed is changed to the target speed by referring to the speed transition map 312. Accordingly, it is possible to set an appropriate target speed by smooth acceleration and deceleration and to efficiently generate electric power.

In this embodiment, the vehicle control device 100 is configured to determine the acceleration and deceleration by referring to the information on the traveling state of another vehicle and the speed transition map 312. Accordingly, it is possible to perform the acceleration and deceleration in consideration of the traveling state of the peripheral vehicle. Thus, it is possible to suppress an accident which may occur with the peripheral vehicle and to efficiently generate electric power.

In this embodiment, the vehicle control device 100 is configured to determine the target speed by referring to the permissible speed map generation unit 307. Accordingly, it is possible to allow the vehicle M to travel at a speed considering the permissible speed at each place on the travel route. Accordingly, it is possible to allow the vehicle to travel at each place on the travel route at a safe speed and to efficiently generate electric power.

In this embodiment, the vehicle control device 100 is configured to determine the target speed by referring to the accident occurrence rate information on the travel route. Accordingly, it is possible to allow the vehicle M to travel at a safe speed without sudden acceleration in a place in which an accident occurrence rate is high on the travel route. Accordingly, it is possible to allow the vehicle to travel safely at each place on the travel route and to efficiently generate electric power.

### Second Embodiment

Next, a second embodiment will be described. In the first embodiment, the vehicle M is an autonomous driving vehicle. In the second embodiment, the vehicle M will be described as the vehicle driven by the driver. Driving by the driver means, for example, that the driver is responsible for all driving tasks. Driving by the driver may not be fully autonomous driving, and for example, any one of the driving support functions such as ACC, LKAS, CMBS, and traffic jam assist function may be turned off. In the following description, the same contents as those described in the first embodiment are designated by the same reference numerals, and the description thereof will be omitted as appropriate.

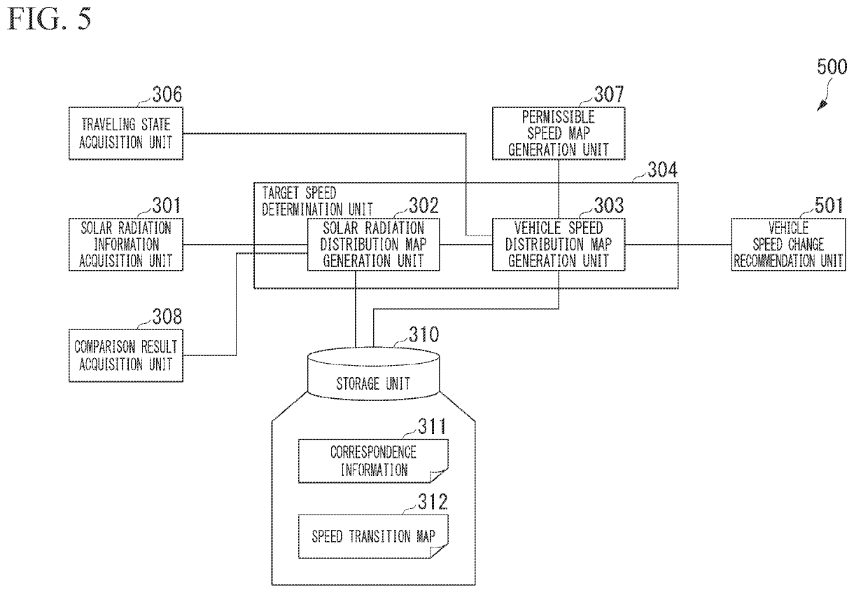

FIG. 5 is a diagram showing an example of the vehicle control device 100 according to the second embodiment. A vehicle control device 500 shown in FIG. 5 is different from the vehicle control device 100 (see FIG. 3) of the first embodiment in that a vehicle speed change recommendation unit 501 is provided instead of the vehicle speed control unit 305. The vehicle speed change recommendation unit 501 recommends the change of the vehicle speed to the driver on the basis of the target speed determined by the target speed determination unit 304. Specifically, the vehicle speed control unit 305 recommends the change of the vehicle speed to the driver on the basis of the information showing the vehicle speed distribution map 220 generated by the vehicle speed distribution map generation unit 303.

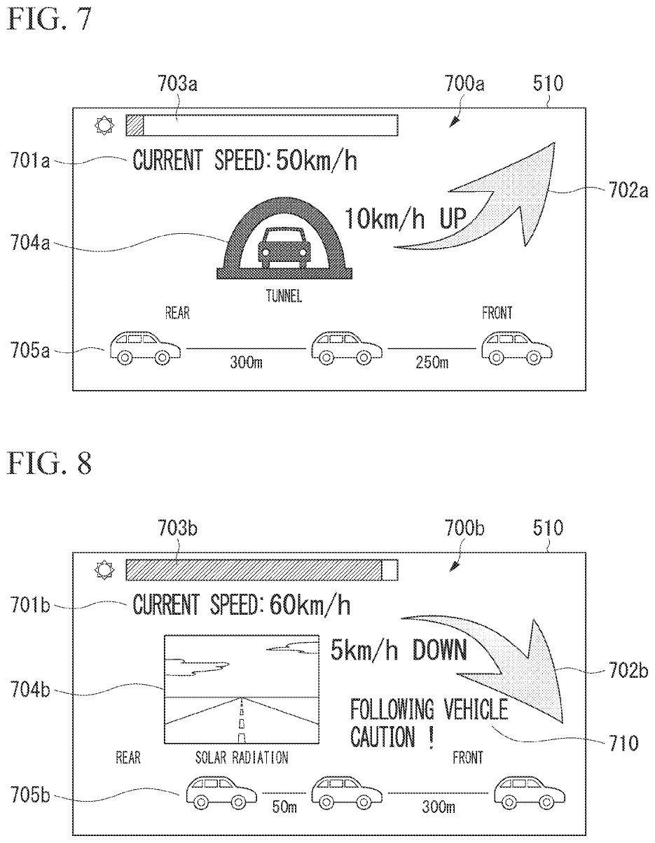

The vehicle speed change recommendation unit 501 notifies, for example, the recommended target speed or target acceleration. For example, when the vehicle travels at a speed different from the target speed, the vehicle speed change recommendation unit 501 displays an arrow on a display 510 (see FIG. 7) and prompts the driver to change the speed according to the direction of the arrow or the color of the arrow. The display 510 may be a head-up display or may be provided on an instrument panel.

The vehicle speed change recommendation unit 501 is not limited to one that visually prompts the vehicle speed change using the display 510 and may prompt the vehicle speed change by hearing or tactile sensation. The operation of prompting the vehicle speed change by hearing means, for example, the operation of prompting the vehicle speed change by sound using a speaker. The operation of prompting the vehicle speed change by tactile sensation means, for example, the operation of prompting the vehicle speed change by a vibration function of an operation unit such as a handle.

The vehicle M according to the second embodiment may be able to switch the autonomous driving and the driving by the driver. That is, the vehicle control device 500 may include function units of the vehicle speed control unit 305 and the vehicle speed change recommendation unit 501 and operate these function units to be switchable depending on the autonomous driving or the driving by the driver.

### [Vehicle Control Process Performed by Vehicle Control Device 500 According to Second Embodiment]

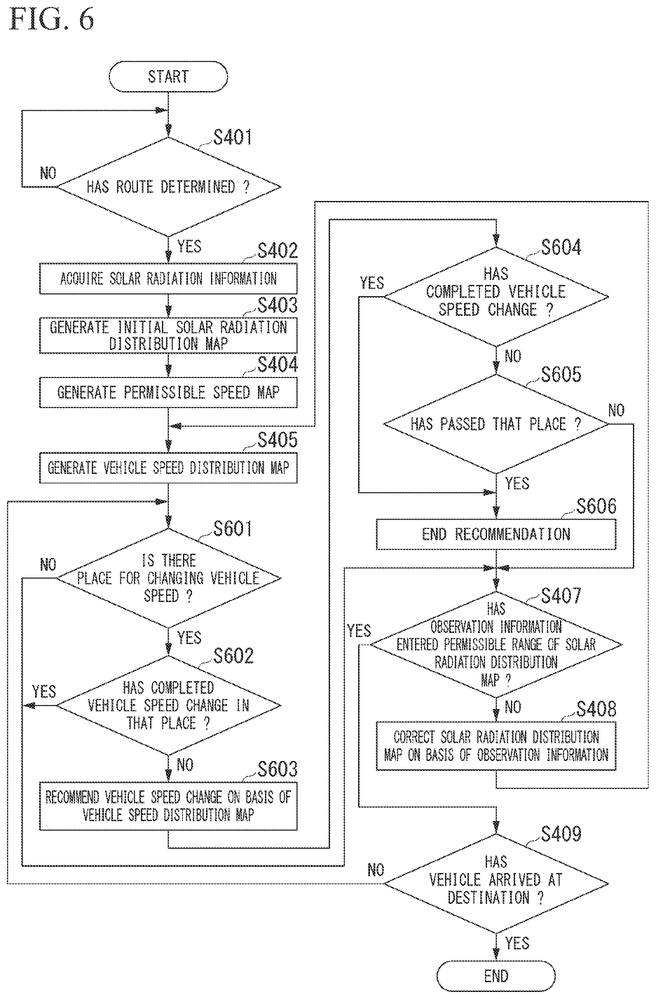

FIG. 6 is a flowchart showing an example of the vehicle control process performed by the vehicle control device 500. The flowchart of FIG. 6 is different from the flowchart of FIG. 4 in that steps S601 to S606 are inserted instead of step S406. Hereinafter, steps S601 to S606 will be described.

In step S405, when the vehicle speed distribution map 220 is generated by the permissible speed map generation unit 307, the vehicle speed change recommendation unit 501 determines if there is a place to change the vehicle speed (step 601). The place for changing the vehicle speed is a place in which the vehicle travels at a target speed different from the target speed set so far. When it is not the place for changing the vehicle speed, the vehicle speed change recommendation unit 501 shifts to step S407. When it is the place for changing the vehicle speed, the vehicle speed change recommendation unit 501 determines whether or not the speed change at that place has been completed (step S602). When the speed change at that place has been completed, the vehicle speed change recommendation unit 501 shifts to step S407.

When the speed change at the place has not been completed, the vehicle speed change recommendation unit 501 recommends the vehicle speed change on the basis of the vehicle speed distribution map 220 (step S603). The vehicle speed change recommendation unit 501 determines whether or not the driver has completed the vehicle speed change by the recommendation of the vehicle speed change (step S604). When the vehicle speed change is completed, that is, the vehicle travels at the target speed, the vehicle speed change recommendation unit 501 shifts to step S606 and ends the recommendation. When the vehicle speed change has not been completed, the vehicle speed change recommendation unit 501 determines whether or not the vehicle has passed the place (step S605).

When the vehicle has not passed the place, the vehicle speed change recommendation unit 501 shifts to step S407. When the vehicle has passed the place, the vehicle speed change recommendation unit 501 ends the recommendation (step S606) and shifts to step S407.

### Screen Example Showing Recommendation of Vehicle Speed Change According to Second Embodiment

FIGS. 7 and 8 are screen examples showing the recommendation of the vehicle speed change according to the second embodiment. In FIGS. 7 and 8, the display 510 displays a recommended screen 700 (700a, 700b). The recommended screen 700 includes a current speed image 701 (701a, 701b), a recommended speed image 702 (702a, 702b), a solar radiation amount image 703 (703a, 703b), a traveling place image 704 (704a, 704b), and a peripheral vehicle image 705 (705a, 705b).

The current speed image 701 shows the current vehicle speed. The recommended speed image 702 shows the recommended vehicle speed. The solar radiation amount image 703 is a gauge display of the current solar radiation amount. The traveling place image 704 shows the traveling place related to solar radiation such as a tunnel and lined trees. The peripheral vehicle image 705 shows the presence/absence of vehicles in front and behind the vehicle and the inter-vehicle distance.

The recommended screen 700a of FIG. 7 shows a screen that prompts acceleration when entering a tunnel. Specifically, the current speed image 701a shows 50 km/h on the recommended screen 700a. The recommended speed image 702a shows that the recommended speed is a speed which is accelerated by 10 km/h. The solar radiation amount image 703a shows that the solar radiation amount is small. The traveling place image 704a shows that the vehicle is traveling in the tunnel. The peripheral vehicle image 705a shows that the peripheral vehicles exist 250 m ahead and 300 m behind. By displaying such a recommended screen 700a, it is possible to allow the driver to recognize that the solar radiation amount is small and to prompt the acceleration.

The recommended screen 700b of FIG. 8 shows a screen that prompts deceleration immediately after exiting the tunnel. Specifically, the current speed image 701b shows 60 km/h on the recommended screen 700b. The recommended speed image 702b shows that the recommended speed is a speed which is decelerated by 5 km/h. The solar radiation amount image 703b shows that the solar radiation amount is large. The traveling place image 704b shows that the vehicle is traveling in a place in which the solar radiation amount is large. The peripheral vehicle image 705b shows that peripheral vehicles exist 300 m ahead and 50 m behind. By displaying such a recommended screen 700b, it is possible to allow the driver to recognize that the solar radiation amount is large and to prompt the deceleration.

As shown in the peripheral vehicle image 705b, there is a following vehicle 50 m behind. If there is a distance with the following vehicle (for example, 100 m or more), the vehicle speed change recommendation unit 501 displays the recommended speed image 702b that prompts the deceleration of 10 km/h. However, since the distance with the following vehicle is short in the example shown in the drawings, the recommended speed image 702b that prompts the deceleration of 5 km/h is displayed. A caution image 710 is displayed on the recommended screen 700b. The caution image 710 is an image that prompts the attention to the rear-end collision of the following vehicle due to deceleration. By displaying such a caution image 710, it is possible to prompt the driver not to perform a sudden deceleration.

As described above, in the second embodiment, the vehicle speed of the vehicle M driven by the driver is controlled on the basis of the determined target speed. Thus, it is also possible to efficiently generate electric power in the vehicle M driven by the driver.

Although the mode for carrying out the present invention has been described using the embodiments, the present invention is not limited to these embodiments and can be modified and substituted in various forms in the scope not departing from the spirit of the present invention.

What is claimed is:

1. A vehicle control device which is used in a vehicle traveling by electric power generated by solar power generation, comprising:
a solar radiation information acquisition unit which acquires solar radiation information showing a solar radiation amount on a travel route which is a planned travel route; and
a target speed determination unit which determines a target speed on the travel route on the basis of the solar radiation information acquired by the solar radiation information acquisition unit and information in which the solar radiation amount is associated with the speed.

2. The vehicle control device according to claim 1,
wherein the vehicle is an autonomous driving vehicle which travels without any operation of a driver, and
wherein the vehicle control device further comprises a vehicle speed control unit which controls a vehicle speed on the basis of the target speed determined by the target speed determination unit.

3. The vehicle control device according to claim 1,
wherein the vehicle is a vehicle which is driven by a driver, and
wherein the vehicle control device further comprises a vehicle speed change recommendation unit which recommends a vehicle speed change to the driver on the basis of the target speed determined by the target speed determination unit.

4. The vehicle control device according to claim 1,
wherein the solar radiation information acquisition unit acquires the solar radiation information at a predetermined timing until the vehicle arrives at a destination, and
wherein the target speed determination unit corrects the target speed on the basis of the solar radiation information acquired at the predetermined timing.

5. The vehicle control device according to claim 4, further comprising:
a comparison result acquisition unit which acquires a comparison result obtained by comparing the solar radiation information acquired at the predetermined timing with the solar radiation information used for determining the target speed,
wherein the target speed determination unit corrects the target speed when the comparison result exceeds a predetermined threshold value.

6. The vehicle control device according to claim 1,
wherein the target speed determination unit determines target acceleration and deceleration when changing the vehicle speed to the target speed on the basis of information on acceleration and deceleration when changing the vehicle speed.

7. The vehicle control device according to claim 6, further comprising:
a traveling state acquisition unit which acquires information on a traveling state of a peripheral vehicle traveling in the periphery of an own vehicle,
wherein the target speed determination unit determines the acceleration and deceleration on the basis of information on the acceleration and deceleration and information on the traveling state.

8. The vehicle control device according to claim 1,
wherein the target speed determination unit determines the target speed on the basis of road restriction information on restrictions on the travel route.

9. The vehicle control device according to claim 1,
wherein the target speed determination unit determines the target speed on the basis of accident occurrence rate information showing an accident occurrence rate on the travel route.

10. A control method of allowing a computer used in a vehicle traveling by electric power generated by solar power generation to acquire solar radiation information showing a solar radiation amount on a travel route which is a planned travel route and determine a target speed on the travel route on the basis of the acquired solar radiation information and information in which the solar radiation amount is associated with the speed.

11. A computer-readable non-temporary storage medium storing a program allowing a computer used in a vehicle traveling by electric power generated by solar power generation to acquire solar radiation information showing a solar radiation amount on a travel route which is a planned travel route and determine a target speed on the travel route on the basis of the acquired solar radiation information and information in which the solar radiation amount is associated with the speed.
